(19) United States
(12) Patent Application Publication
(10) Pub. No.: US 2002/0010785 A1
(43) Pub. Date: Jan. 24, 2002

(54) Application hosting apparatus

(76) Inventors: Yasufumi Katsukawa, Kawasaki (JP); Toshiya Yamazaki, Kawasaki (JP)

Correspondence Address: STAAS & HALSEY LLP, 700 11TH STREET, NW, SUITE 500, WASHINGTON, DC, 20001, US

(21) Appl. No.: 09/799,502

(22) Filed: Mar. 7, 2001

(30) Foreign Application Priority Data
Jul. 19, 2000 (JP) 2000-218325

(51) Int. Cl. G06F 15/173; G06F 15/16

(52) U.S. Cl. 709/229; 709/225

(57) ABSTRACT

A service provider having various application servers gains access first to a relay server when a client which has been registered in the relay server intends to use a service provided by the service provider. Then, the relay server certifies the client and connects the client to the service provider. The relay server also performs an accounting operation incidental to services used by the client. For this purpose, a member/accounting management server is connected to the relay server and a database required for this purpose is provided by the member/accounting management service.

### BACKGROUND OF THE INVENTION

1. Field of the Invention

The present invention relates to a hosting apparatus for hosting an application.

2. Description of the Related Art

With the popularization of communication via the Internet and full equipment of network infrastructure, agent employment of application servers for business applications, package software and the like has been rapidly increased. In the current trend mentioned above, a provider possessing an application requires a system through which the application can be quickly hosted. In addition, a user requires a system through which the user can effectively utilize application hosting services which are now still increasing.

In a conventional application hosting service, each application server performs a certifying process to identify a user and stores log information, such as a user's history of utilization and the like required when a fee for the service is charged. The user of the service performs steps of certification for each application and receives a detailed statement of a fee charged for utilization of each application. In a case that an application hosting service is to be started, an application service dealer has to install systems for certifying and accounting processes for each application and hence the cost and time for developing the system for this purpose is incurred. However, a user of the application hosting service has to perform steps for certification and fee payment for each application, so that every time the user utilizes a plurality of application services, the user has to execute certifying procedures and receive a plurality of detailed statements based on different accounts, which is inefficient and complicated.

### SUMMARY OF THE INVENTION

An object of the present invention is to provide a hosting apparatus through which an application service dealer can realize a service business at a low cost and in a short period of time and a user can commonly execute the certifying and accounting processes for the plurality of application services.

A hosting apparatus according to the present invention is of the type for mediating between a client and a service provider for providing an application service by an application server and is characterized by comprising:

certifying means for certifying a user of the client based on information on the user who uses the client; certification data storing means for storing data required for the user to log into the application server in a case that the application server has a proprietary certifying system; and automatic log-in means for automatically allowing a user whose certification has been accepted by the certifying means to log into the application server based on the data stored in the certification data storing means.

In the present invention, a relay server acting as a hosting apparatus is installed between the client and the application server. A plurality of application servers and a plurality of clients are connected to the relay server. The relay server operates such that when log-in information used to log each user into each application service is required, the log-in information is held for each user who is registered in the relay server and after the user has successfully logged into the relay server, the logging of each user into each application server is automatically performed. Therefore, the user can utilize all of the application servers simply by logging into the relay server.

In addition, for a service provider having application servers, not only an application server which is newly registered in the relay server but also an application server having a proprietary certifying system can be readily accomodated in the relay server. That is, it becomes possible for the user to use a target application by simply logging in one time (into the relay server) even in the case that the application server has its original certifying system.

Further, fees for accesses to a plurality of application servers are batch-charged by the relay server, so that it becomes simple for the user to manage his service utilizing state and it becomes possible for the service provider to start the service business in a short period of time because there is no need for the service dealer to incorporate an accounting system into its application server.

### BRIEF DESCRIPTION OF THE DRAWINGS

Next, the present invention will be described in more detail with reference to the accompanying drawings. In the drawings,

FIG. 1 is a diagram showing the structure of a system for performing certifying and accounting processes according to an embodiment of the present invention;

FIG. 2 is a diagram showing the structure of data for defining service information;

FIG. 3 is a diagram showing the structure of data for defining the type of client appliance of a user;

FIG. 4 is a diagram showing the structure of data for defining user group information;

FIG. 5 is a diagram showing the structure of data for defining access right information in units of group;

FIG. 6 is a diagram showing the structure of data of individual certification information for application servers;

FIG. 7 is a diagram showing an example displayed on a log-in screen;

FIG. 8 shows examples of displayed menus;

FIG. 9 is a diagram showing a sequence executed when a user makes a service request to an application server via a relay server;

FIG. 10 is a flowchart of processes, starting with acceptance of the first service request by the relay server and ending with a start of provision of an application service;

FIG. 11 is a detailed flowchart of a user judging process shown in FIG. 10;

FIG. 12 is a detailed flowchart of an access right judging process shown in FIG. 10;

FIG. 13 is a flowchart of a process executed when the relay server receives a service response from the application server;

FIG. 14 is a diagram showing an example of a detailed statement; and

FIG. 15 is a diagram showing an example of a hardware environment required when functions of the relay server and member/accounting management server according to the present invention are to be implemented in accordance with a program.

### DESCRIPTION OF THE PREFERRED EMBODIMENT

In the present invention, a relay server is installed between a client and an application server to execute as a proxy certifying and accounting processes to be executed by individual application servers. In addition, application hosting service users are unifiedly managed to prepare a detailed statement through which certification of each user for a plurality of application servers and charging of fees for a plurality of services are batch-settled as one account.

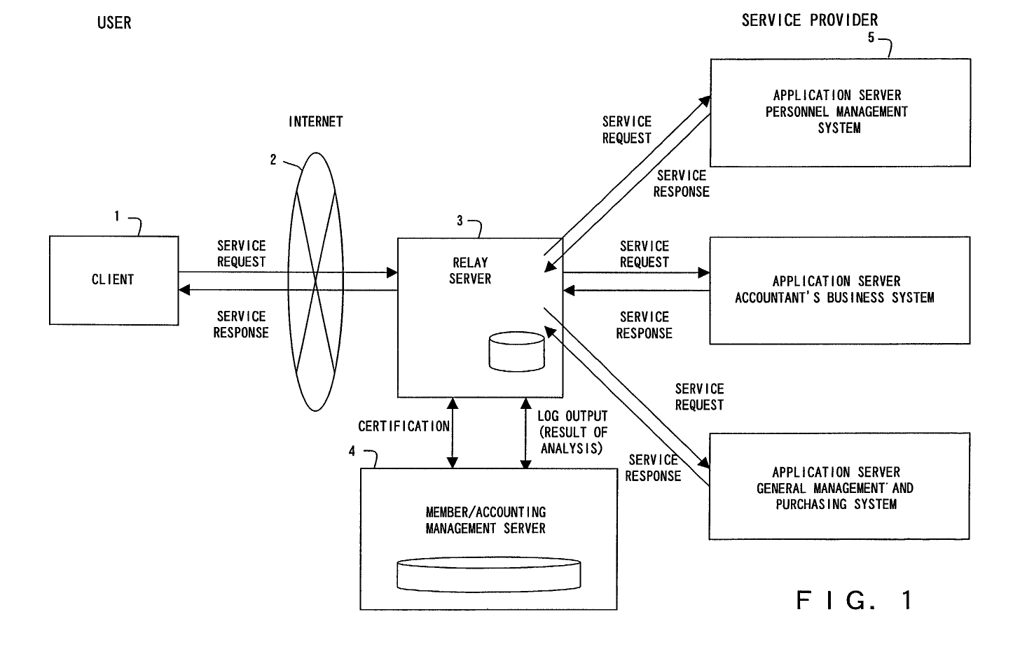

FIG. 1 is a diagram showing the structure of a system for performing certifying and accounting processes according to an embodiment of the present invention. In the drawing, 1 denotes a terminal of a user of an application hosting service, 2 denotes the Internet (it is apparent that other network is applicable) as a network, 3 denotes a relay server, 4 denotes a member/accounting management server for unifiedly managing users of application hosting services and for storing history logs outputted from the relay server, and 5 denotes an application server of a service dealer.

When the client 1 makes a service request to the relay server 3 via the Internet 2, a certifiction screen is presented from the relay server 3 to the client 1. Then, a user ID, a password and the like are inputted as certification information from the client 1 to be sent to the relay server 3. Then, the relay server 3 certifies a user who uses the client 1 based on the certification information sent from the client 1. At that time, the relay server 3 refers to a database in the member/accounting management server 4 to verify whether the user is a member for using a hosting service. When the user is certified, the service request is transmitted to each service provider 5 and then an application screen provided from each service provider 5 is outputted to the client 1. The relay server 3 acquires data indicating which service the user has been given via the relay server 3 in accordance with the certification of the user and in the form of a log and records this log in the database of the member/accounting management server 4.

As application services provided by the service providers 5, a personnel management system, accountant business system, general management and purchasing system and the like are available. However, the present invention is not limited to these systems.

When the client 1 logs off from the service provided by the service provider 5, the client 1 also logs off from the relay server 3. As a result of this logging-off operation, the use of the service by the client 1 via the relay server 3 comes to an end and recording of the log by the relay server 3 also comes to an end. Then, the relay server 3 subsequently analizes the contents recorded in the log and calculates how many times the user of the client 1 has used the services of specific service provider 5 to generate accounting information. Then, the accounting information is sent to the user of the client in the form of a detailed statement of service utilization. The relay server 3 generates the accounting information with reference to the database of the member/accounting management server 4 in which there are recorded data on how to charge the client 1 per service provider 5. As described above, the system is constructed such that all of the service requests from the user pass through the relay server 3.

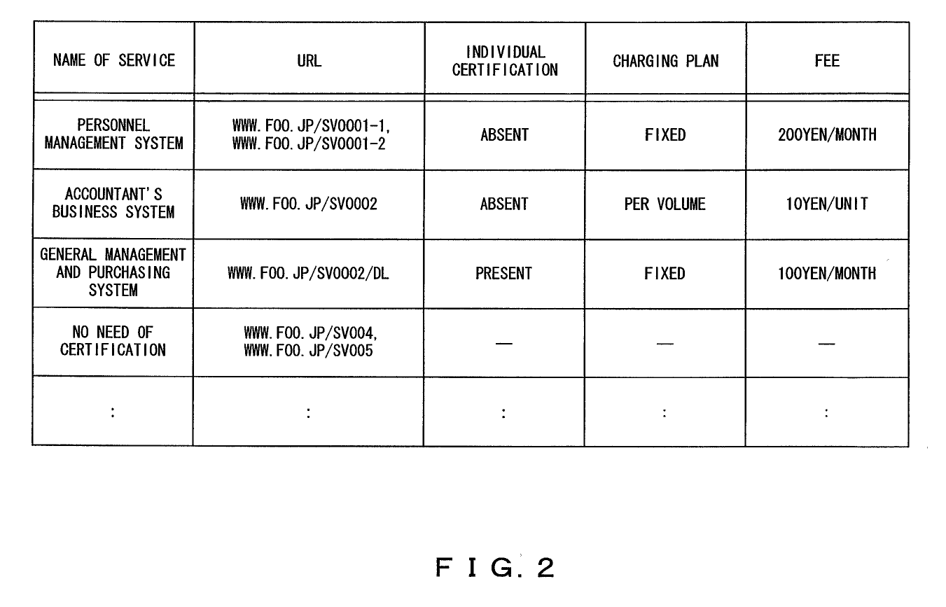

FIG. 2 is a diagram showing the structure of data for defining service information.

First, a service dealer who wants to start an application hosting service and the system according to the embodiment of the present invention defines services to be provided through the service provider's application server in the database of the relay server in the form of the data structure shown in FIG. 2. As a format of registering the service information defining data, there may be employed a conventional data inputting technique on a network.

In this service information defining data, there are defined names of services, URLs of Web pages for providing the services, individual certification and accouting information such as charging plans, charging systems and the like for each service for which the user is certified and the fee is charged. For instance, in the example shown in FIG. 2, the service of the personnel management system is provided through a Web page having the URL of “www.foo.jp/sv0001-1, www.foo.jp/sv0001-2”, under the condition that the individual certification (on the application side) is not required (it is absent), the charging plan is “fixed”, and 200 yen is paid per month. Other services are provided under the same conditions as the above. In a case that the certifying process is bypassed through the relay server, a URL which makes the certification unnecessary may be defined.

Users who want to use the system according to the embodiment of the present invention should register their names as members in the relay server.

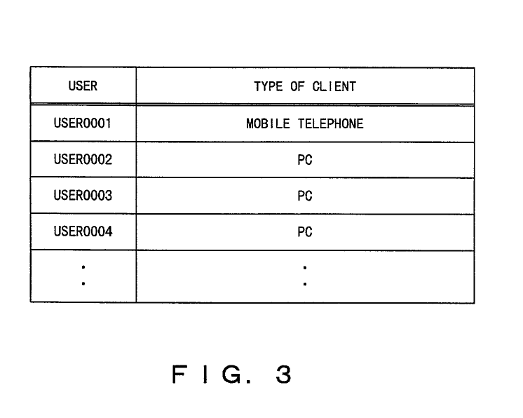

FIG. 3 is a diagram showing the data structure of data for defining the types of client appliances of users.

In FIG. 3, “user0001 . . . user0004 are registered as users and the types of clients are registered such that a mobile telephone is registered as the type of client of the user “user0001” and PCs are registered as the types of clients of users “user0002” to “user0004”.

In addition, in a case that the users are registered, the users may be grouped so as to define services which can be made available group by group.

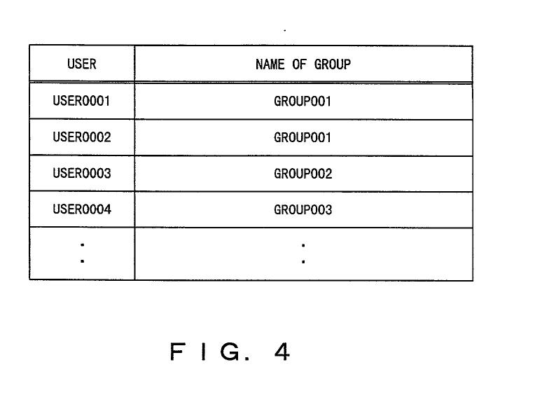

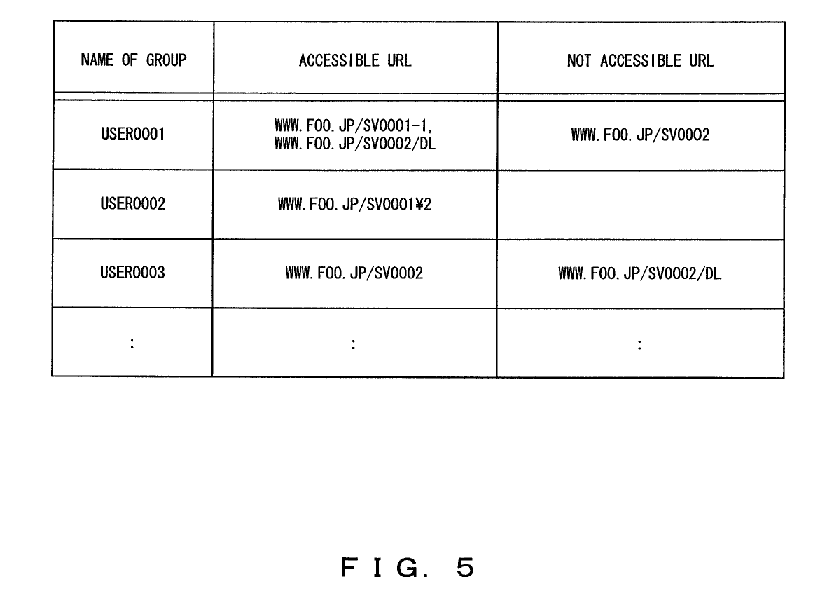

FIG. 4 is a diagram showing the data structure of data for defining user group information and FIG. 5 is a diagram showing the data structure of data for defining access right information.

In the example shown in FIG. 4, “user0001 . . . user0004” are registered as users and users “user0001” and “user0002” are grouped into the same group named “group0001” and users “user0003” and “user0004” are respectively grouped into groups “group0002” and “group0003”.

In FIG. 5, accessible URLs and inaccessible URLs are set for each group. That is, “www.foo.jp/sv0001-1” and “www.foo.jp/sv0002/dl are set for the group “group0001” as accessible URLs and “www.foo.jp/sv0002 is set for the group “group0001” as the inaccessible URL. www.foo.jp/sv0001-2 is set for the group “group0002” as the accessible URL and nothing is set for the group “group0002” as the inaccessible URL. www.foo.jp/sv0002 is set for the group “group0003” as the accessible URL and www.foo.jp/sv0002/dl is set for the group “group0003” as the inaccessible URL.

Therefore, in accordance with the situations shown in FIGS. 4 and 5, users “user0001” and “user0002” can access “www.foo.jp/sv0001-1” and “www.foo.jp/sv0002/dl and cannot access “www.foo.jp/sv002. The same also applies to users “user0003” and “user0004”.

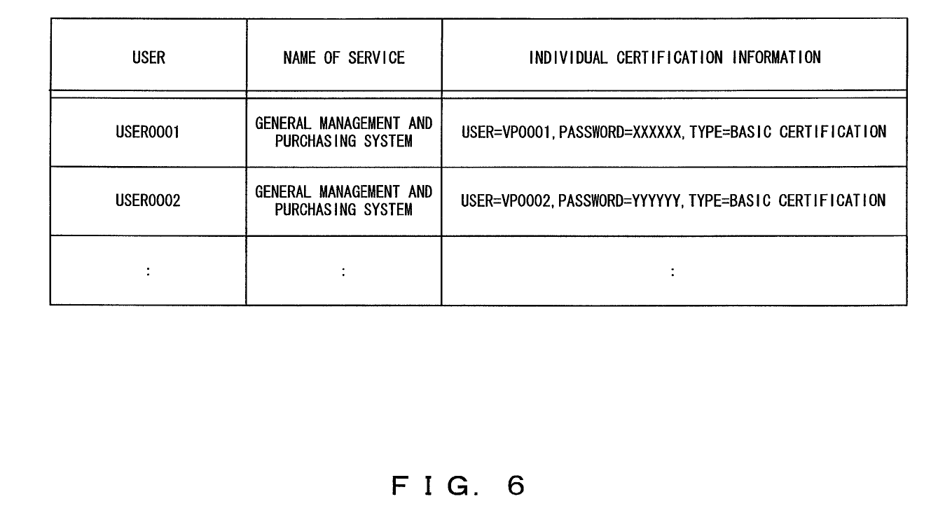

FIG. 6 is a diagram showing the data structure of data of individual certification information for the application servers. In a case that individual certifying procedures are performed on the side of the application server, the individual certification information is defined based on the data structure shown in FIG. 6.

For example, in FIG. 6, in a case that the user “user0001” utilizes the service of the general management and purchasing system, individual certification is performed on the side of the server of the general management and purchasing system and such information where the user ID is “vp0001”, the password is “xxxxxx” and the certifying method is “BASIC certification” is registered as the certification information of the user “user001” to be used at that time. Here, the BASIC certification means the standard certifying system in the current WWW (World Wide Web). In the example shown in FIG. 6, information on the user “user0002” is registered in the same manner as described above.

In a case that the individual certification information for the application servers shown in FIG. 6 is set, after the certification for the relay server performed in accordance with the service request from the user, the relay server refers to the individual certification information for the application server shown in FIG. 6 and transmits the user ID, the password and the like required for the certification of the user concerned on the side of the application server in accordance with the certifying method which has been thus set so as to automatically perform individual certification without requiring the user to input the certification information into the application server.

In a case that a currently operating application server acceses a hosting service provided by the relay server, the possibility that this application server already has a proprietary certification/accounting system is high, so that the user has to be again certified separately when the user gains access to this application server after certification is made for the relay server when no special procedures are taken. In order to eliminate an inconvenience such as the one mentioned above, the data structure for the individual certification is provided such that the data required to log-in to the application server is held on the side of the relay server so as to be accessible to any application server simply by logging into the relay server. It is apparent that there is no need for an application server which newly enters the hosting service provided by the relay server to have a proprietary certifying/accounting system. Accordingly, there is no need for the relay server to hold data of individual certification for this application server.

As described above, the service information, the member information, the group information, the access right information and the application server individual certification information are unifiedly managed in the database of the member/accounting management server.

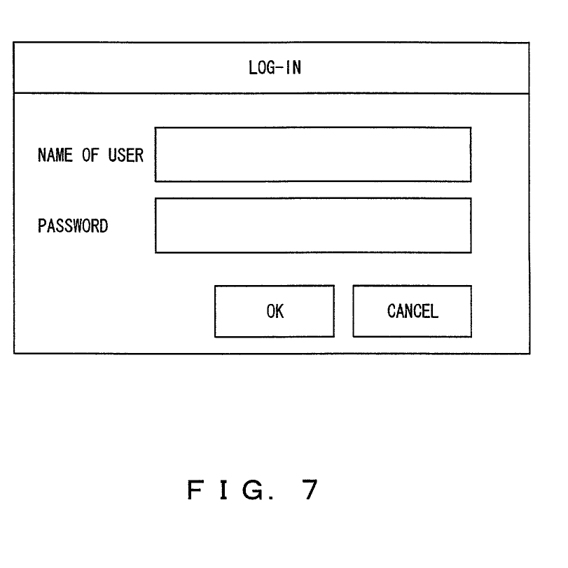

FIG. 7 is a diagram showing an example displayed on a log-in screen.

In a case that the user wants to utilize the service provided by the application server, the user transmits a service request including a destination to which the service is requested through the client 1. The relay server 3 receives the service request from the client 1 and fetches the account information. In a case that the account of the user is not present, it is judged whether the URL of the destination from which service is requested needs no certification. When the certification is not needed, the service request is transferred to the application server 6. However, when the certification is needed, the log-in screen shown in FIG. 7 is displayed on the client 1 in order to receive the user's account. At that time, in a case that the communication protocol is HTTP, a log-in screen for BASIC certification may be displayed.

In a case that the user's account is contained in the service request, the account information is fetched from this service request and this account information is collated with the information registered on the side of the member/accounting management server 4. In a case that the user is not a normally registered user, it is judged whether the URL of the destination from which service is requested needs no certification. When the certification is not needed, this service request is transferred to the application server 6. However, in a case that the certification is needed, user access is rejected.

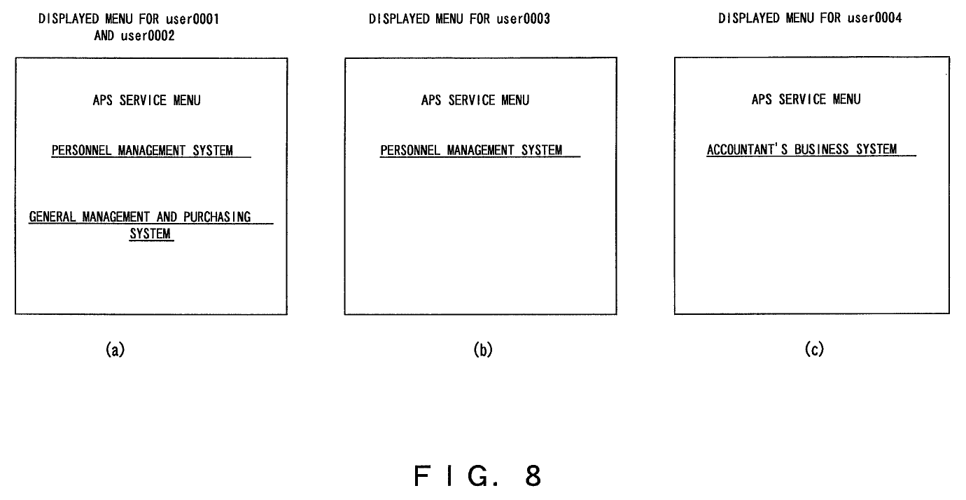

In a case that the user is the normally registered user, when the service request contains a request for menu display, services to which the user can access are retrieved from the access right information and display menus shown in FIG. 8 are prepared to be displayed on the client 1. When a service other than the menu display is requested, it is judged whether the access right is present.

As described above, FIG. 8 shows examples of menus to be displayed.

FIG. 8 (a) shows a display example of an ASP (Application Service Provider) service menu for the users “user0001” and “user0002”. As shown in FIG. 4, the users “user0001” and “user0002” belong to the group “group0001” and hence can use the personnel affairs system and the general management and purchasing system as is apparent from FIGS. 2 and 5. Likewise, as shown in FIG. 8(b), the user “user0003” can use the personnel management system and as shown in FIG. 8(c), the user “user0004” can use the accountant business system.

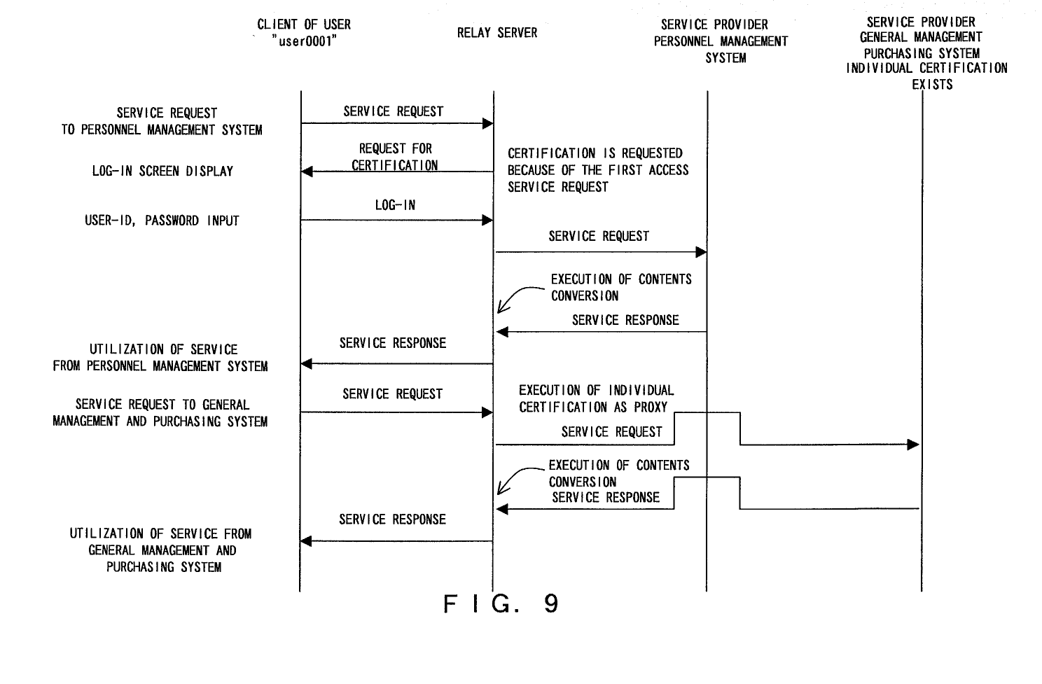

FIG. 9 is a diagram showing a sequence performed when a user sends a service request to the application server via the relay server.

FIG. 9 shows the sequence performed when the user “user0001” intends to use the personnel management system and the general management and purchasing system.

First, a service request made to the personnel management system is transmitted from the user “user0001” or the client and this service request is received by the relay server. In this case, the user “user0001” accesses the relay server for the first time, so that the relay server displays the log-in screen for the user “user0001”. Then, the user “user0001” inputs his user ID and password to be transmitted to the relay server. When the user is successfully certified by the relay server, the service request is transmitted to the personnel management system of the service provider. The personnel management system makes a service response to the relay server in response to the service request from the relay server and transmits the contents for providing the service to the relay server. Upon reception of the contents from the personnel management system, the relay server refers to the not accessible URLs for the user “user0001” and the type of the terminal of the user “user0001” to make a response for providing the service by deleting a link to the not accessible URL from within the displayed contents of the personnel management system, by converting the contents so they can be displayed on the screen of a mobile telephone set, and by transmitting the converted contents to the user “user0001”, which make it possible for the user “user0001” to use the personnel management system. Then, in a case that the user “user0001” intends to use the general management and purchasing system provided by another service provider, the user “user0001” transmits a service request to the general management and purchasing system to the relay server. The relay server acquires the fact that the general management and purchasing system needs the individual certification from the database and transmits the user ID and password of the user “user0001” required for the individual certification to the general management and purchasing system, according to the adopted certifying method, to execute the individual certifying process as a proxy, and simultaneously with this process, the relay server sends the service request to the general management and purchasing system. After the individual certification has been successfully performed, the general management and purchasing system transmits a service response to the relay server. Upon reception of this service response, the relay server converts the contents of the general management and purchasing system in the same manner as described above to send the service response to the user “user0001”. As a result, it becomes possible for the user “user0001” to use the service of the general management and purchasing system.

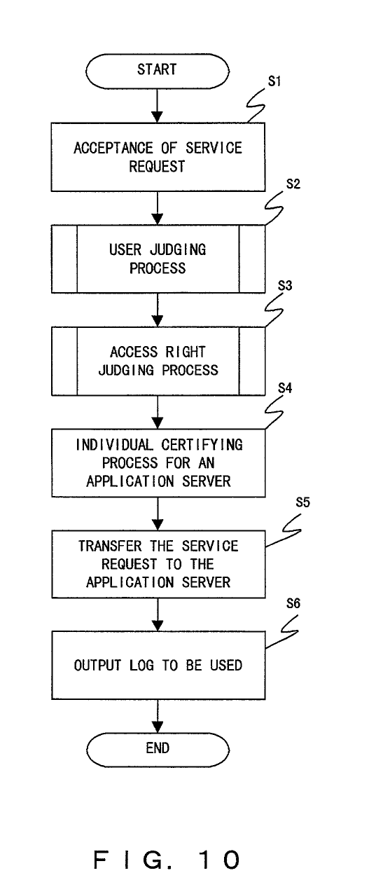

FIG. 10 is a flowchart of processes executed by the relay server starting with the acceptance of the first service request and ending with a start of provision of the application service.

First, the first service request is accepted at a step S1. Then, a user judging process is executed at a step S2. The user judging process will be described in detail later. Then, an access right judging process is executed at a step S3. The access right judging process will also be described in detail later. Then, an individual certifying process for an application server is executed at a step S4. It is apparent that when the application server does not need the individual certification, no particular process is executed. Then, the service request is transferred to the application server at a step S5 and a log to be used is outputted at a step S6.

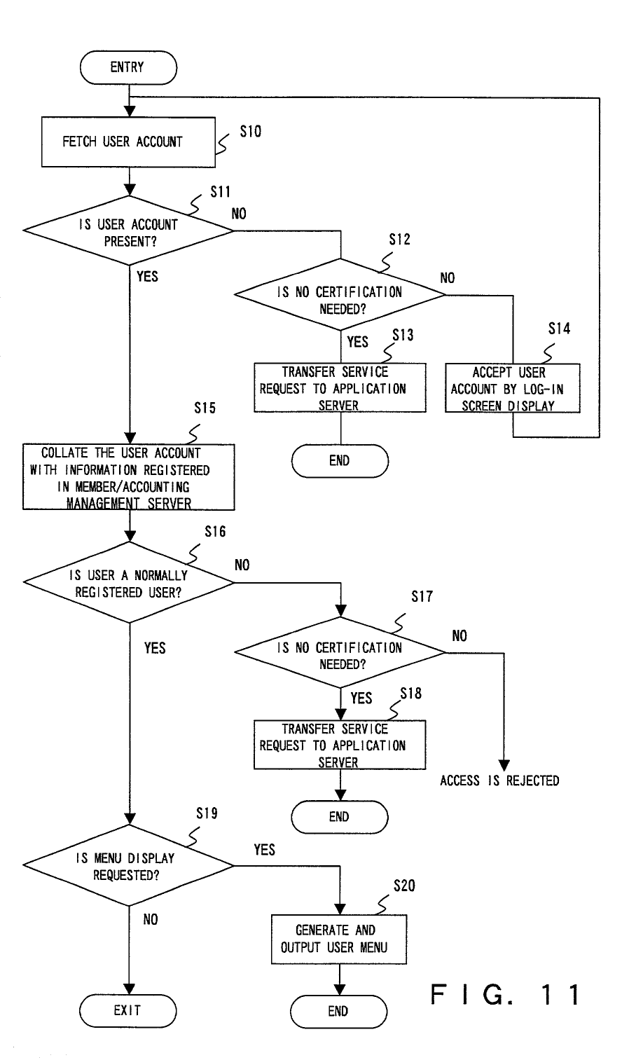

FIG. 11 is a detailed flowchart of the user judging process in FIG. 10.

First, the user's account is fetched by the service request at a step S10. Then, it is judged whether the user's account is fetched, that is, whether this service request contains relevant user account information at a step S11. When, no relevant user account information is contained in the service request, it is judged whether the application server that the user intends to use needs certification by the user at a step S12. When the certification is not needed, the service request is transferred to the application server at a step S13. However, when it is judged that the certification is needed at the step S12, the log-in screen is presented to the user at a step S14 to receive the user's account information. Then, the flow returns to the step S10 and the preceeding processes are repeated.

In a case that it is judged that the user's account was acquired at the step S11, the user's account is collated with the information registered in the member/accounting management server, and it is judged whether the user is a normally registered user at a step S16. In a case that it is judged that the user is not the normally registered user at the step S16, it is judged whether an application server to which the user intends to access needs certification by the user at a step S17. When the certification is not needed, the flow proceeds to a step S18 where the service request is transferred to the application server, at which point the process is completed. However, when it is judged that the certification is needed at the step S17, user access is rejected.

When it is judged that the user who accessed the application server is the normally registered user at the step S16, it is judged whether the service request from the user is a request for menu display at a step S19. When it is judged that this request is the request for menu display, menus for the user are generated and outputted at the step S20, at which point the process is completed. However, when it is judged that this service request is not the request for menu display at the step S19, it is judged that the user judging process has come to an end and control exits from this process flowchart.

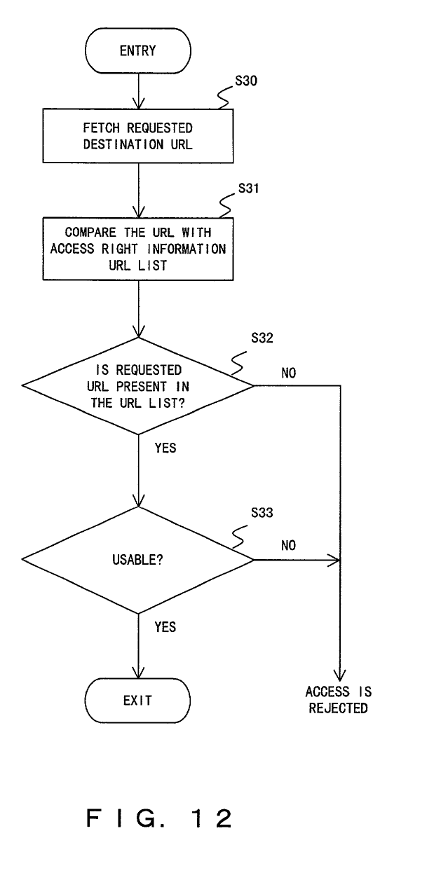

FIG. 12 is a detailed flowchart of the access right judging process in FIG. 10.

First, a requested destination URL contained in the service request is fetched at a step S30. The fetched URL is collated with a list of access right information URLs at a step S31. It is judged whether the URL requested from the user is present in the list of URLs at a step S32. If the requested URL is not present therein, user access is rejected. However, if the requested URL is present in the list of URLs at the step S32, it is judged whether it is a URL which is usable by the user who made the service request at a step S33. If it is not a usable URL, user access is rejected. However, if it is a usable URL, it is judged that the access right judging process is completed and control exits from this process flowchart.

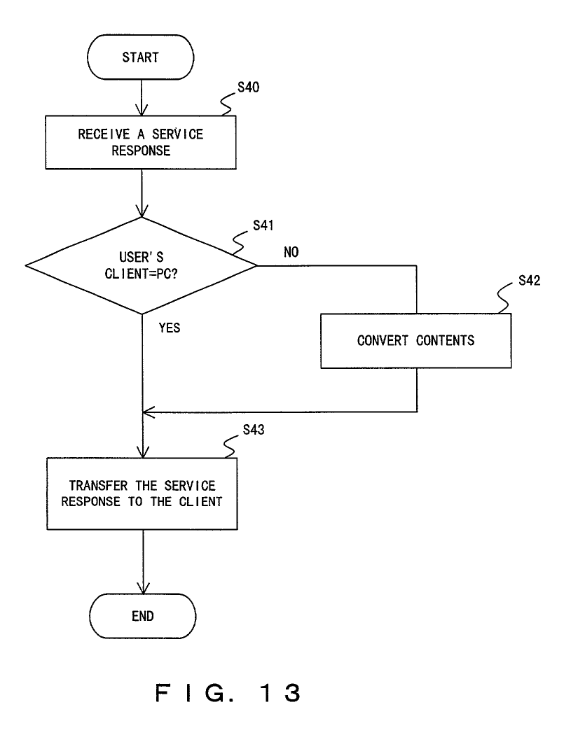

FIG. 13 shows a flowchart of a process executed when the relay server receives a service response from the application server.

First, when the service response is received at a step S40, it is judged whether the appliance (client) of the user is a PC at a step S41. In a case that the client is a PC, the service response is transferred to the client at a step S43. However, when it is judged that the client is not a PC at the step S41, the contents are converted so they can be displayed on a small-sized appliance suh as a mobile telephone or the like at a step S42 and then the service response is transferred to the client at the step S43.

Here, as a trigger for the conversion of contents, the judgement is made only as to whether the client is a PC. However, other elements may be taken into consideration. For example, as described above, this process may be designed such that it is judged whether a link to a URL to which the user cannot access is contained in the contents, and when the link is contained in the contents, the contents are converted so as to remove this link and then the service response is transferred to the client.

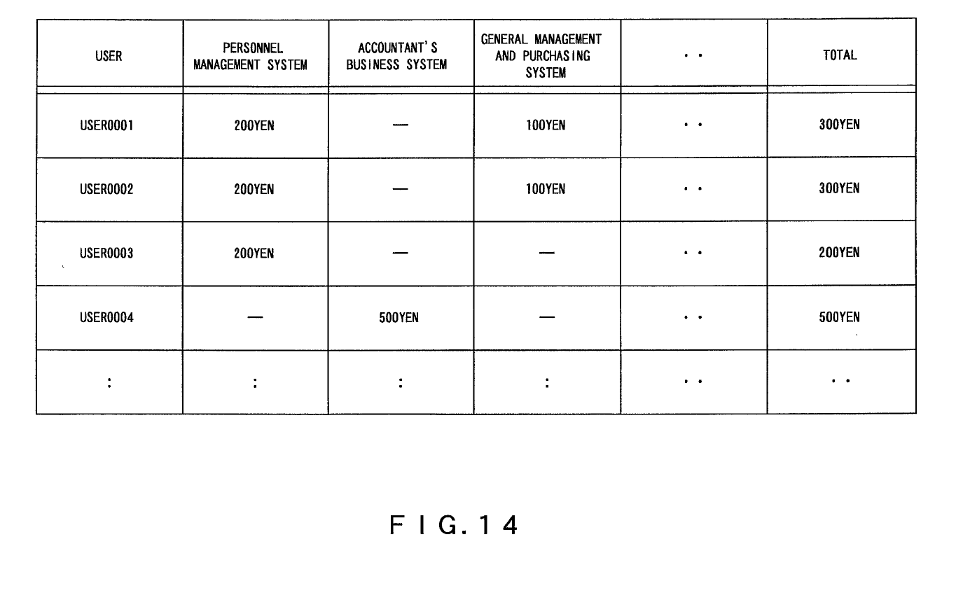

As described above, in the process of judging the access right shown in FIG. 12, the relay server fetches the URL of the destination to which the service request is made by the service request from the client to collate the URL with the access right information in the member/accounting management server 4. At that time, the access right information may be cached on the relay server. When it is judged that the user has the access right, it is checked whether the application server needs the individual certification with reference to the individual certification information for the application server shown in FIG. 6. When the application server does not need the individual certification, the service request is transferred to the application server possessing the service of the requested destination. However, when the individual certification is needed, the relay server executes the certifying procedures as a proxy in accordance with the individual certification information. Thereafter, the service request is transferred to the application server possessing the service of the requested destination. When the service request is transferred to the application server, the history log is outputted to the relay server. The history log is then transferred to the member/accounting management server, in which fees are then calculated and then a detailed statement having the data structure shown in FIG. 14 is prepared. In this case, the hysteresis may be outputted onto the member/accounting management server 4 immediately after preparation of the detailed statement is made.

After the service request has been transferred to the application server, the relay server receives the service response from the application server. At that time, the type of the client of the user is judged and when it is not a PC, the contents are converted into the form which can be handled by the appliance of the user and then the service response is transferred to the client.

As described above, FIG. 14 shows an example of a detailed statement.

In the detailed statement according to the embodiment of the present invention, the application server used by each user and the duration of use are indicated to each user and the total amount of money to be charged is calculated for each user. In a prior art, each application server has its original certification and accounting systems, so that when a plurality of application servers are used, a plurality of detailed statements are sent from the plurality of application servers to the user. However, according to the embodiment of the present invention, the fees for the services which are performed via one relay server are batch-charged, so that even when the user uses the plurality of application servers, the fees for the services which are provided to the user from the plurality of application servers are entered in one detailed statement and the total amount of money to be charged is calculated and is made known to the user. Accordingly, it becomes unnecessary for a service provider having an application server to perform the accounting process by itself by participating in a hosting service provided by the relay server, so that the investment required for the provision of the service can be reduced. In addition, the fees for the services that the user has used are batch-charged, so that the user can see at a glance what kind of service he has used and to what extent.

In the above mentioned embodiment, an example in which only one relay server is provided has been described. Alternatively, a plurality of relay servers may be connected to the individual application servers. However, in this case, common databases for storing the certification information and the accounting information are provided in the plurality of relay servers so as to execute the certifying processes and the accounting processes as a batch.

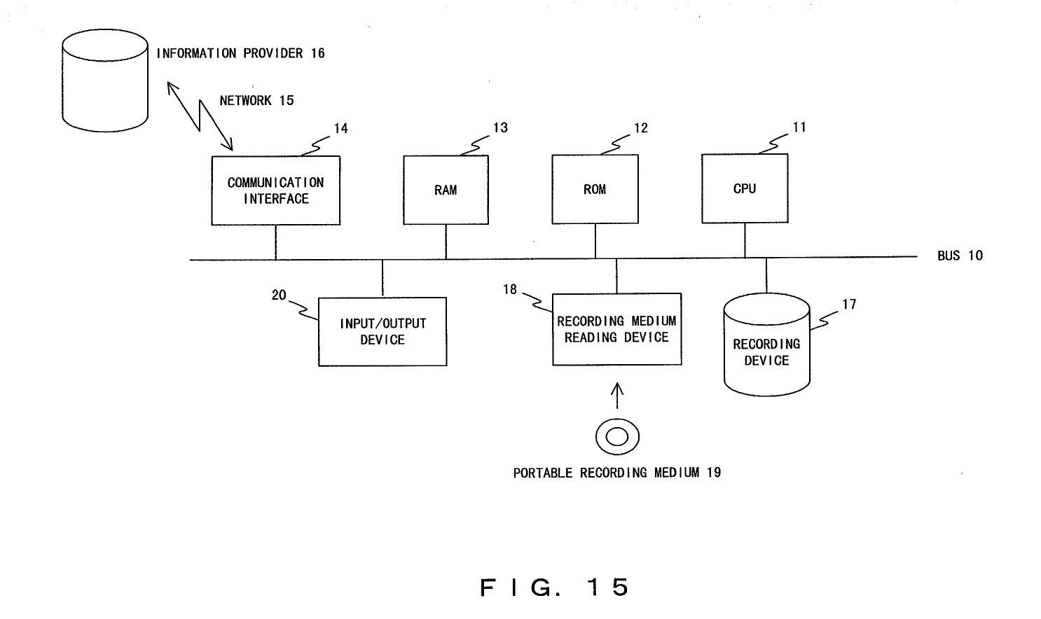

FIG. 15 is a diagram showing an example of a hardware environment needed when the functions of the relay server and the member/accounting management server according to the embodiment of the present invention are implemented in accordance with a program.

A CPU 11 is connected to a ROM 12, a RAM 13, a communication interface 14, a recording device 17, a recording medium reading device 18 and an input/output device 20 via a bus 10. The program for implementing the embodiment of the present invention is recorded in the ROM 12, the recording device 17 and a portable recording medium 19. Various kinds of databases are stored in the recording device 17 or the portable recording medium 19. The recording device 17 is constituted, for example, by a hard disk and the portable recording medium 19 is constituted, for example, by a CD-ROM, a floppy disk, a DVD or the like. The program or data recorded in the portable recording medium 19 is downloaded from the recording device 17 into the RAM 13 via the recording medium reading device 18, which allows the program to be executed by the CPU 11. In order to permit the CPU 11 to control the recording medium reading device 18 and the recording device 17, or the input/output device 20 and the communication interface 14 which are used by an administrator of the information apparatus shown in FIG. 15 when the information apparatus is controlled, a basic program such as a BIOS or the like is stored in the ROM 12. The basic program is executed when the power source of the information apparatus is turned on. The input/output device 20 is constituted, for example, by a display, a keyboard, a mouse and the like. Instead of the above, the program for implementing the embodiment of the present invention may be downloaded from an information provider 16 on a network 15 by communication using the communication interface 14 to be executed, or the program may be stored in a database of the information provider 16 without constructing the various databases in the portable recording medium 19 and the recording device 17. Alternatively, the program for implementing the embodiment of the present invention is not downloaded from the information provider, but may be executed in a state that the information apparatus is connected with the information provider 16 on the network 15, that is, within the network environment.

According to the present invention, it becomes unnecessary for the service provider which starts the application hosting business to individually package the certifying and accounting processes on the application server, so that the cost involved with the development can be reduced accordingly and the time required for starting the service can be shortened. Conventionally, the user had to execute the certifying procedures with the use of accounts which are different for different applications and had to receive the plurality of detailed statements. However, according to the present invention, the user can execute the certifying procedures by a single signing-on operation with the use of one common account and can receive one detailed statement in which the fees for the plurality of services are batch-charged, so that the user can use the services efficiently. While the invention has been described with reference to the preferred embodiment thereof, various modifications and changes may be made by those skilled in the art without departing from the true spirit and scope of the invention as defined by the claims thereof.

What is claimed is:

1. A hosting apparatus for mediating between a client and a service dealer for providing an application service by an application server, comprising:
a certifying unit certifying a user of said client based on information of the user who uses said client;
a certification data storing unit storing data required for the user to log into said application server when said application server has its original certifying system; and
an automatic log-in unit automatically making the user whose certification has been successfully performed by said certifying unit, log-in to said application server.

2. The hosting apparatus according to claim 1, wherein a list of services which are usable by each user is prepared for each user, and when a service request is made by the client, said list is collated with the user certification information of said client to judge whether said user has a right to access said service.

3. The hosting apparatus according to claim 1, wherein the certification of the user is performed for the plurality of application services with the use of one piece of common log-in information.

4. The hosting apparatus according to claim 1, further comprising:
an accounting unit performing accounting for the user when the user used the service provided by said application server, thereby preparing, for each user, a detailed statement in which fees for services provided by the plurality of application servers are batch-charged.

5. The hosting apparatus according to claim 1, wherein in setting a right to access the application service by said application server, users are grouped together and the right of access to the service is set for each group.

6. The hosting apparatus according to claim 1, wherein when the user accesses a portal site (entry) of said hosting apparatus, URL menus of applications usable by said user are displayed.

7. A hosting method of mediating between a client and a service provider for providing a service by an application server, comprising:
certifying a user of said client based on information on the user who uses said client;
storing data required for said user to log-in to said application server when said application server has a proprietary certifying system; and
automatically making the user whose certification has been successfully performed at said certifying step, log-in to said application server based on the data stored at said certification data storing step.

8. A recording medium for recording a program for making an information apparatus implement a method of mediating between a client and a service dealer for providing a service by an application server, constituting a hosting method comprising:
certifying a user of said client based on information on the user who uses said client;
storing data required for said user to log-in to said application server when said application server has a proprietary certifying system; and
automatically making the user whose certification has been successfully performed at said certifying step, log-in to said application server based on the data stored at said certification data storing step.
